(19) United States
(12) Patent Application Publication
(10) Pub. No.: US 2019/0130251 A1
(43) Pub. Date: May 2, 2019

(54) NEURAL QUESTION ANSWERING SYSTEM

(71) Applicant: Google LLC, Mountain View, CA (US)

(72) Inventors: Ni Lao, Belmont, CA (US); Chen Liang, Evanston, IL (US); Quoc V. Le, Sunnyvale, CA (US); John Blitzer, Mountain View, CA (US)

(21) Appl. No.: 16/176,961

(22) Filed: Oct. 31, 2018

Related U.S. Application Data
(60) Provisional application No. 62/579,771, filed on Oct. 31, 2017.

(51) Int. Cl. G06N 3/04; G06F 17/30; G06F 17/27; G06K 9/62

(52) U.S. Cl. CPC G06N 3/04; G06K 9/6215; G06F 17/2735; G06F 17/30976

(57) ABSTRACT

Methods, systems, and apparatus, including computer programs encoded on a computer storage medium, for generating a system output from a system input using a neural network system comprising an encoder neural network configured to, for each of a plurality of encoder time steps, receive an input sequence comprising a respective question token, and process the question token at the encoder time step to generate an encoded representation of the question token, and a decoder neural network configured to, for each of a plurality of decoder time steps, receive a decoder input, and process the decoder input and a preceding decoder hidden state to generate an updated decoder hidden state.

### CROSS-REFERENCE TO RELATED APPLICATION

This application claims priority to U.S. Provisional Application No. 62/579,771, filed on Oct. 31, 2017. The disclosure of the prior application is considered part of and is incorporated by reference in the disclosure of this application.

### BACKGROUND

This specification relates to neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

Some neural networks are recurrent neural networks. A recurrent neural network is a neural network that receives an input sequence and generates an output sequence from the input sequence. In particular, a recurrent neural network can use some or all of the internal state of the network from a previous time step in computing an output at a current time step.

### SUMMARY

This specification describes a system implemented as computer programs on one or more computers in one or more locations. In particular, the system includes an encoder neural network configured to: receive an input sequence comprising a respective question token at each of a plurality of encoder time steps, and for each of the encoder time steps, process the question token at the encoder time step to generate an encoded representation of the question token. The system also includes a decoder recurrent neural network configured to, at each of a plurality of decoder time steps: receive a decoder input at the decoder time step, and process the decoder input and a preceding decoder hidden state to generate an updated decoder hidden state for the decoder time step. The system further includes a subsystem configured to: at each of the encoder time steps: determine whether the question token at the encoder time step satisfies one or more criteria for adding a variable representing the question token to a vocabulary of possible outputs; and when the question token at the encoder time step satisfies the one or more criteria, add the variable to the vocabulary of possible outputs and associate the encoded representation of the question token as an encoded representation for the variable. The subsystem is also configured to: at each of the decoder time steps: determine, from the updated decoder hidden state at the decoder time step and from respective encoded representations for possible outputs in the vocabulary of possible outputs, a respective output score for each possible output in the vocabulary of possible outputs, and select, using the output scores, an output from the vocabulary of possible outputs as a decoder output at the decoder time step.

Particular embodiments of the subject matter described in this specification can be implemented so as to realize one or more of the following advantages. The system may be used to perform semantic parsing a large search space, such as a knowledge base. The system provides effective results, (i.e., answers to questions), on challenging semantic parsing datasets. For example, the system may receive questions as input, and provide answers to the questions efficiently, over a large search space. In some aspects, the system may take natural language as input and map the natural language input into a function. The function may be a sequence of tokens that reference functions, operations, or values stored in memory. In some aspects, the system may execute functions and/or partial functions to leverage semantic denotations during the search for a correct function that, when executed, generates an answer that corresponds to the natural language input. In some aspects, the system may execute functions and/or partial functions to leverage semantic denotations during the search for a correct function that, when executed, generates an answer that corresponds to the natural language input.

The system executes functions in a high level programming language using a non-differentiable memory. The non-differentiable memory enables the system to perform abstract, scalable, and precise operations, to provide answers to questions received as input. In some aspects, the non-differentiable memory is a key-variable memory that saves and reuses intermediate execution results. The system can be configured to provide a neural computer interface that detects and eliminates invalid functions, (i.e., functions that do not yield correct answers to corresponding questions), among the large search space. Additionally, the system is trained end-to-end and does not require feature engineering or domain-specific knowledge. The system integrates neural networks with a symbolic non-differentiable computing device to support abstract, scalable, and precise operations through a neural computing interface.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 shows an example neural question answering system.

FIG. 2 shows an example workflow for a neural question answering system.

FIG. 3 is a flow diagram of an example process for outputting an answer to an input question.

FIG. 4 is a flow diagram of an example process for adding a variable to a vocabulary of possible outputs.

FIG. 5 is a flow diagram of an example process for selecting an output from a vocabulary of possible outputs using output scores.

FIG. 6 is a flow diagram of an example process for executing a function to determine a function output.

FIG. 7 is a flow diagram of an example process for selecting an output from a vocabulary of possible outputs using logits.

Like reference numbers and designations in the various drawings indicate like elements.

### DETAILED DESCRIPTION

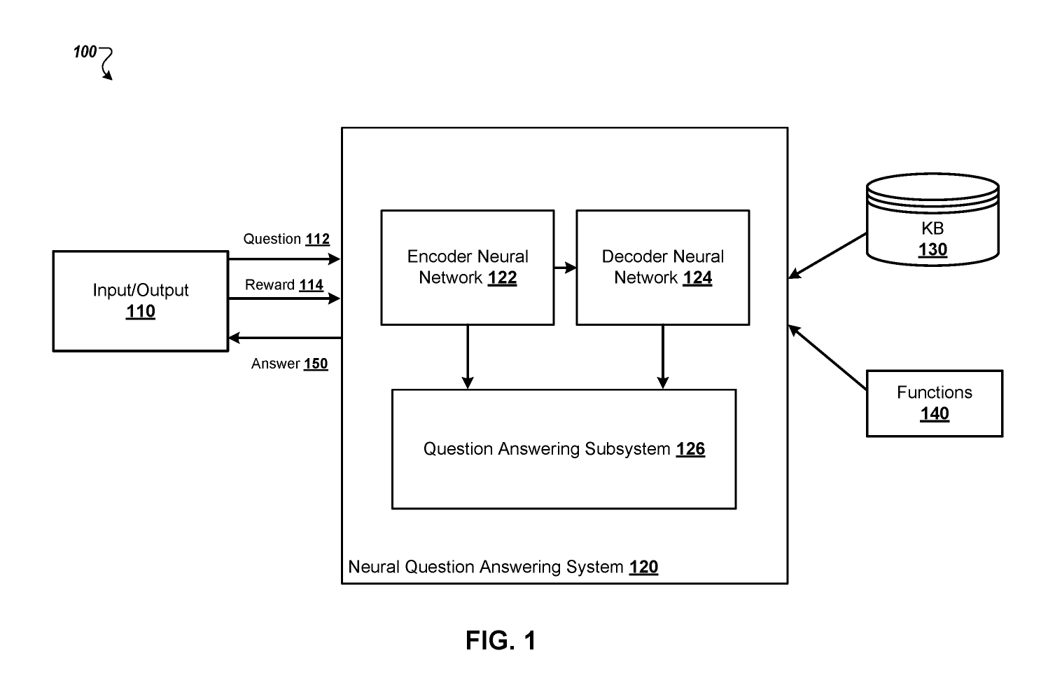

FIG. 1 shows an example neural question answering system 120. The neural question answering system 120 is an example of a system implemented as computer programs on one or more computers in one or more locations, in which the systems, components, and techniques described below are implemented.

The neural question answering system 120 is a machine learning system that receives system inputs and generates system outputs from the system inputs. For example, the system 120 may receive a natural language question 112 as a system input and generate an answer 150 to the natural language question as a system output. The question 112 may be provided to the neural question answering system 120 by a user device over a data communications network, e.g., the Internet, and the neural question answering system 120 may provide the answer 150 as a response to the received question 112. The user device that provides input and receives output may be, e.g., a smartphone, a laptop, a desktop, a tablet, a smart speaker or other smart device, or any other type of user computer. In some implementations, a user of the neural question answering system 120 can submit the question as a voice query, and the neural question answering system 120 can provide a spoken utterance of the answer 150 as part of a response to the voice query, i.e., for playback by the user device.

Generally, the neural question answering system 120 generates answers to questions, e.g., the answer 150, by executing functions 140 against a knowledge-base (KB) 130. For example, the neural question answering system 120 may provide answers to questions about information stored in the KB 130. The information stored in the knowledge base may be, for example, data identifying entities and attributes of the entities. For example, the KB 130 may be a collection of structured data that identifies attributes of entities of one or more types, e.g., people, places, works of art, historical events, and so on.

In some aspects, the neural question answering system 120, after receiving the question 110, the neural question answering system 120 searches a large search space of possible functions for a particular function that, when executed by the neural question answering system 120 against the information stored in the KB 130, generates the answer 150 that corresponds to the received question 110.

The neural question answering system 120 includes an encoder neural network 122, a decoder neural network 124, and a question answering subsystem 126.

The encoder neural network 122 is a recurrent neural network, e.g., a gated recurrent unit neural network (GRU) or a long short-term memory neural network (LSTM), that receives the question 112 and maps each token in the question 112 to a respective encoded representation. That is, given a sequence of words in natural language format, the encoder neural network 122 maps each of the words in the input sequence to a respective encoded representation. The encoded representations are an ordered collection of numeric values, such as a vector of floating point values or a vector of quantized floating point values. In particular, at each encoder time step, the encoder neural network 122 receives the input at the time step and updates an encoder hidden state and generates the encoded representation for the input.

The decoder neural network 124 is also a recurrent neural network that is configured to, at each of multiple decoder time steps, receive a decoder input at the decoder time step and process the decoder input and the preceding decoder hidden state to generate an updated decoder hidden state for the decoder time step.

At each decoding time step, the question answering subsystem 126 uses the updated decoder hidden state to generate an output for the decoder time step. In particular, the outputs generated by the subsystem 126 are tokens from computer program expressions that include, for each of a plurality of functions, a function identifier for the function and possible arguments to the function. The question answering subsystem 126 may execute one or more of the particular functions, as defined by the outputs selected at the decoder time steps, to generate an answer, and the answer may be provided by the neural question answering system 120 as the answer 150 to the question 112.

Specifically, the decoder neural network 124 is trained to generate decoder outputs that are used by the subsystem 126 to represent and refer to intermediate variables with values stored in the neural network system 120. The neural network subsystem 126 stores the intermediate variables in a key-variable memory. In this instance, each intermediate variable includes an encoded representation v, and a corresponding variable token R that references the value in the memory.

In some aspects, the neural question answering system 120 uses the last hidden state of the encoder neural network 122 as the initial state of the decoder neural network 124.

The encoder neural network 122 and the decoder neural network 124 are trained with weak supervision using an iterative maximum-likelihood (ML) procedure for finding pseudo-gold functions 140 that will bootstrap a REINFORCE algorithm. REINFORCE is used because the question answering subsystem 126 executes non-differentiable operations against the KB 130, i.e., because the functions performed by the subsystem 126 are non-differentiable. As such, an end-to-end backpropagation training procedure can be problematic in training the question answering subsystem 126.

Therefore, the question answering subsystem 126 is trained according to a REINFORCEMENT learning problem such as the following: given a question x, the state of the neural question answering system 120, a particular action determined by the question answering subsystem 126, and a reward 124 at each time step t ∈{0, 1 , . . . T} are (Sₜ, αₜ, rₜ). Due to the deterministic environment of the neural question answering system 120, the state of the neural question answering system 120 is defined by the question x and the action sequence: sₜ=(x, α_{0:t-1}), where α_{0:t-1}=(α₀ , . . . , αₜ₋₁) is the history of actions at time t.

A valid action at time t is αₜ∈A(sₜ), where A(sₜ) is a set of valid tokens output by the question answering subsystem 126. In this instance, each action corresponds to a token, and the full history of actions α_{0:T} correspond to a function. The reward for a particular question, such as reward 114 for question 112, can be referred to as rₜ−I[t−T]*F₁(x,α_{0:T}). The reward 114 may include one or more rewards that correspond to the natural language questions, and indicate how well the neural question answering system 120 answered the question 112 during raining. The reward is non-zero at the last decoding time step, and is the F₁ score computed by comparing the gold answer and the answer generated by executing the function α_{0:T}. Therefore, the reward of function α_{0:T} is characterized by the following:

R(x, α_{0:T})=Σₜrₜ=F₁(x, α_{0:T})

While REINFORCE assumes a stochastic policy, beam search may be used to train the neural question answering system 120 for gradient estimation. Therefore, a predetermined number of top-k action sequences, such as functions 140, may be used in the beam with normalized probabilities. The use of the top-k action sequences used in the beam with normalized probabilities allows the neural question answering system 120 to be trained with sequences of tokens that have a high probability of yielding a correct answer to a given question. By training the neural question answering system 120 with sequences of tokens that have a high probability, the variance of the gradient may be reduced.

Additionally, the neural question answering system 120 is trained using iterative maximum-likelihood (ML). Iterative ML is used to search for good or correct functions 140 given fixed parameters, and to optimize the probability of the “best” function for producing a correct answer at a given point in time, (i.e., selecting an output from the vocabulary of possible outputs). For example, decoding is performed by the decoder neural network 124 with a large beam size. In this instance, a pseudo-gold function is declared based on the highest achieved reward with the shortest length, among functions 140 decoded in all previous iterations of decoding. The ML objective is further optimized so that a particular question is not mapped to a function if the question is found to not include a positive, corresponding reward.

Iterative ML is used during training to train for multiple epochs after each iteration of decoding. This iterative process includes a bootstrapping effect in which an efficient neural question answering system 120 leads to a better function (that yields the correct answer to a given question) through decoding, and a better function leads to an efficient neural question answering system through training.

Although a large beam size may be used in training, some functions 140 are difficult to find using the neural question answering system 120, due to a large search space. The large search space may be addressed through the application of curriculum learning during the training. The curriculum learning is applied during training by gradually increasing the set of functions 140 used by the subsystem and the length of the function when performing iterative ML. However, the incorporation of iterative ML uses pseudo-gold functions 140 that make it difficult to distinguish between tokens that are related to one another. One way to aid in the differentiation between related tokens, is to combine iterative ML with REINFORCE to achieve augmented REINFORCE.

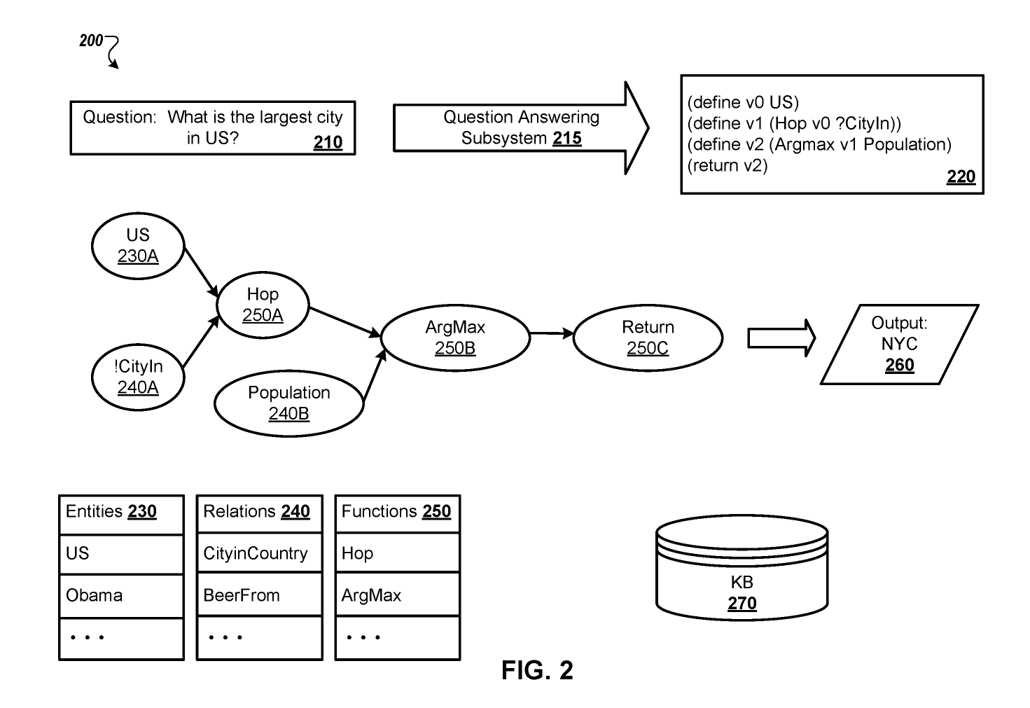

FIG. 2 shows an example workflow 200 for a neural question answering system. The workflow 200 describes an end-to-end neural network that performs semantic parsing over a large search space such as a knowledge-base (KB). The workflow 200 includes a question 210 that is provided as input, a question answering subsystem 215 for processing the question 210, a non-differentiable interpreter 220, entities 230, relations 240, functions 250, an output 260 or answer to the question 210, and a KB 270.

The question answering subsystem 215 represents a semantic parser as a sequence to sequence deep learning model. For example, the question answering subsystem 215 can provide answers to questions about information in the KB 270 by executing functions against the KB. By using semantic and syntactic constraints over a large search space, the question answering subsystem 215 may restrict the search space of logic forms to produce the correct answer to the corresponding question 210.

The question 210 can include one or more questions that are input to the question answering subsystem 215. In some aspects, the question 210 can include a natural language question such as “What is the largest city in the US?” In this instance, the question 210 may be provided to the question answering subsystem 215 for processing, to provide an answer the question 210.

The question answering subsystem 215 can be configured to perform semantic parsing using structured data, such as data in the knowledge-base (KB) 270. For example, the question answering subsystem 215 can be configured to perform voice to action processing, as a personal assistant, speech to text processing, and the like. Specifically, the question answering subsystem 215 can be configured to map received questions, such as question 210, to predicates defined in the KB 270. As such, the question answering subsystem 215 can process the semantics of a question that involves multiple predicates and entities 230 with relations 240 to the predicates. The semantics of the question 210 may be processed to select a function that can be executed to provide an answer to the question 210.

The question answering subsystem 215 may use a neural computer interface that includes a non-differentiable interpreter 220 to process the natural language questions, such as question 210. The non-differentiable interpreter 220 may be used as an integrated development environment to reduce the large search space (over the KB 270) for the question 210. For example, the interpreter 220 may be used by the question answering subsystem 215 to process the question 210 “What is the largest city in the US?”

The interpreter 220 may be used to extract entities 230 and relations 240 from the question 210. Further, the interpreter 220 may be used to determine functions 250 to select in the generation of an answer to the question 210. In this instance, the interpreter 220 may be used to extract the entity of US 230A, the relations CityIn 240A and Population 240B, and the functions Hop 250A, ArgMax 250B, and Return 250C. The entities 230, relations 240, and functions 250 will be discussed further herein.

The non-differentiable interpreter 220 may also be used to exclude invalid choices when mapping the question 210 to a particular function that is executed to generate an answer. The non-differentiable interpreter 220 may be used by the question answering subsystem 215 to remove potential answers that cause a syntax or semantic error. For example, the question answering subsystem 215 may use the non-differentiable interpreter 220 to perform syntax checks on arguments that follow particular functions 250, and/or semantic checks between entities 230 and relations 240.

The KB 270 can include data identifying a set of entities 230, (i.e., US, Obama, etc.) and a set of relations 240 between the entities 230, (i.e., CityinCountry, BeerFrom, etc.). The entities 230 and the relations 240 may be stored as triples in the KB 270. In some examples, a triple may include assertions such as {entity A, relation, entity B} in which entity A is related to entity B by the relation in the triple.

The question answering subsystem 215 can be configured to produce and/or access a function 250 that is executed against the KB 270 to generate a correct answer or output to the question 210. The potential answers to the question 210 may be generated by the execution of tokens from computer program expressions. The tokens may include a function identifier that corresponds to a particular function in the list of functions 250, as well as a list of possible arguments to the particular function. For example, the question 210 may be “What is the largest city in the US?” In this instance, the question answering subsystem 215 may 210 extract the entity “US” and the relation “city in” from the question 210. The question answering subsystem 215 can be configured to use the interpreter 220 to execute the Hop 250A function with the entity US 230A and the relation !Cityin 240A. The question answering subsystem 215 may also extract the term “largest” from the question 210 to define a second relation Population 240B to be used in combination to execute a second function 250B.

The question answering subsystem 215 uses an encoder neural network and a decoder neural network to define functions 250 that take the entities 230 and relations 240 as input, to provide a correct answer to the question 210 as output 260. Referring to FIG. 2, the question answering subsystem 215 executes the functions 20A-C to generate the correct answer to the question 210. In this instance, the question answering subsystem 215 generates NYC as the answer to the question 210 and provides NYC as output 260.

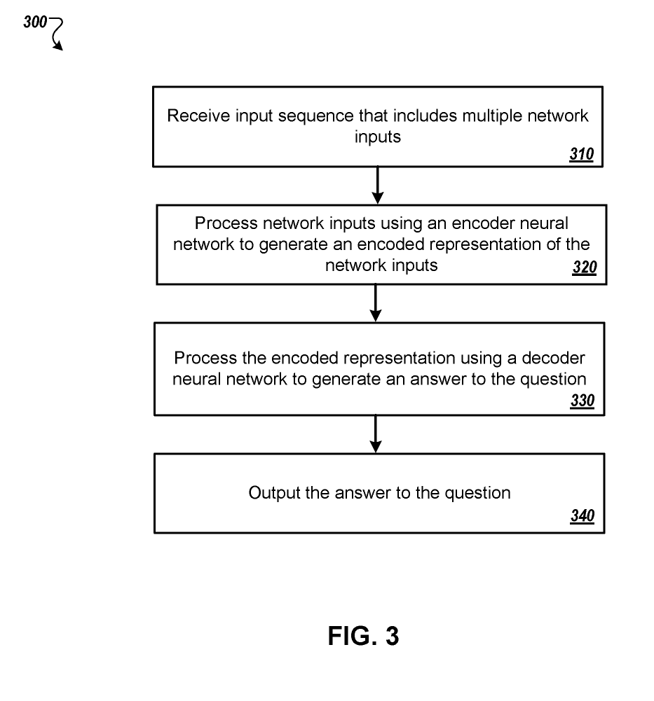

FIG. 3 is a flow diagram of an example process 300 for outputting an answer to an input question. For convenience, the process 300 will be described as being performed by a system of one or more computers located in one or more locations. For example, a neural question answering system, e.g., the neural question answering system 120 of FIG.1, appropriately programmed in accordance with this specification can perform the process 300.

At step 310, the system receives an input sequence that includes multiple question tokens. The input sequence can correspond to a natural language question referencing one or more entities in a knowledge base (KB). The neural question answering system may receive the input sequence as a respective question token at each of a plurality of time steps.

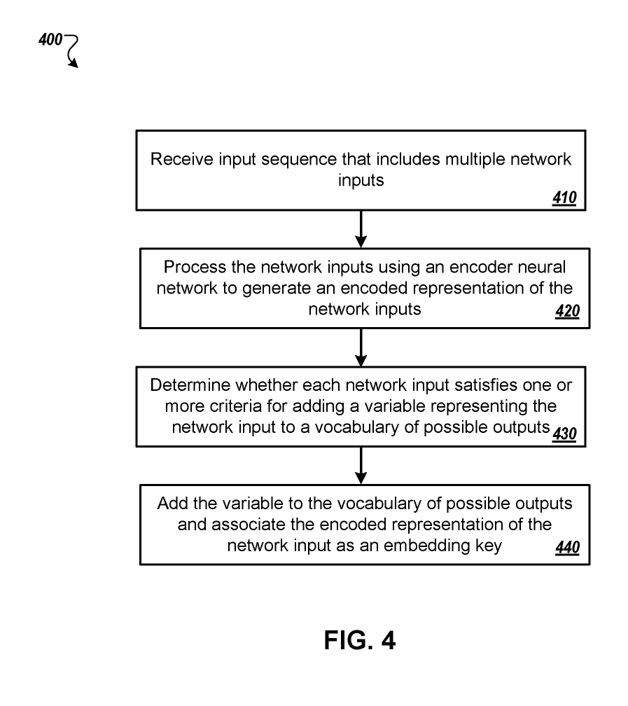

At step 320, the neural question answering system processes the question tokens using an encoder neural network. The neural question answering system uses the encoder neural network to generate an encoded representation of each of the question tokens. The neural question answering system generates the encoded representation by processing question tokens corresponding to the input sequence at each of a plurality of time steps. The processing of the input sequence to generate encoded representations of the input sequence is further described in FIG. 4. As part of processing the question tokens, the system also determines whether the question token at the encoder time step satisfies one or more criteria for adding a variable representing the question token to a vocabulary of possible outputs and, if so, adds the variable to the vocabulary of possible outputs and associate the encoded representation of the question token as an encoded representation for the variable. Adding variables to the vocabulary of possible outputs is also described below with reference to FIG. 4.

At step 330, the neural question answering system processes the encoded representations of the inputs in the input sequence. The neural question answering system uses the decoder neural network to generate an answer to the question represented by the input sequence. The neural question answering system processes the encoded representation of the question tokens at each of a plurality of decoder time steps. In some aspects, the neural question answering system may use the decoder neural network to search a large search space for a particular function that, when executed by the neural question answering system, generates the answer that corresponds to the received input sequence or question.

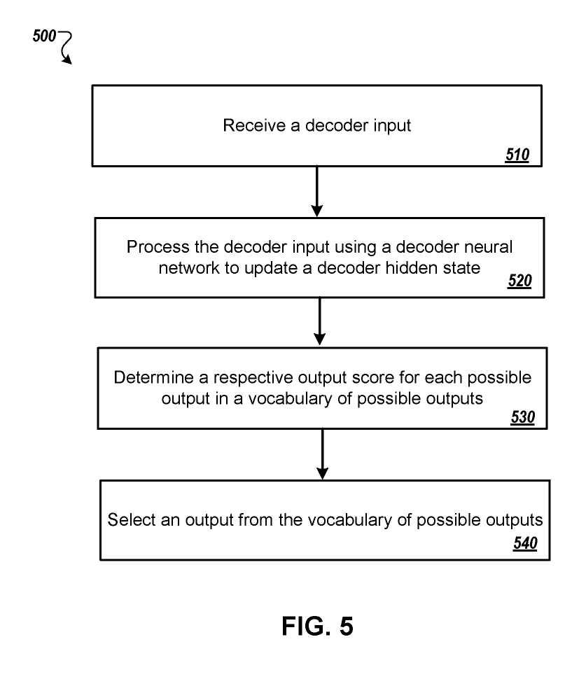

In particular, at each decoder time step, the system generates a decoder input for the time step that includes, e.g., the encoded representation of the output at the preceding time step, processes the decoder input using the decoder neural network to generate an updated decoder hidden state, and then uses the decoder hidden state to select an output for the time step. When criteria are satisfied, the system executes a function from a set of functions using the decoder outputs that have been generated. When the processing has completed, the system selects the most recently generated function output as the system output for the input question. The processing of the encoded representations by the decoder neural network is further described in FIG. 5.

At step 340, the neural question answering system outputs the answer to the question. The answer may correspond to an answer of a natural language question. The answer can include one or more answers produced by functions that are executed by the neural question answering system, against the knowledge-base. For example, the neural question answering system provides answers to questions about information stored in the KB.

FIG. 4 is a flow diagram of an example process 400 for adding a variable to a vocabulary of possible outputs. For convenience, the process 400 will be described as being performed by a system of one or more computers located in one or more locations. For example, a neural question answering system, e.g., the neural question answering system 120 of FIG. 1, appropriately programmed in accordance with this specification can perform the process 400.

At step 410, the neural question answering system receives an input sequence that includes multiple question tokens. The input sequence can correspond to a natural language question referencing one or more entities in a knowledge base (KB). The neural question answering system may receive the input sequence as a respective question token at each of a plurality of time steps.

At step 420, the neural question answering system processes the question tokens using an encoder neural network. The neural question answering system uses the encoder neural network to generate an encoded representation of each of the question tokens. The neural question answering system generates the encoded representation by processing question tokens corresponding to the input sequence at each of a plurality of time steps.

At step 430, the neural question answering system determines whether each question token satisfies one or more criteria for adding a variable representing the question token to a vocabulary of possible outputs. For example, the neural question answering system may be configured to determine whether the question token at each of a plurality of encoder time steps satisfies the one or more criteria. In some aspects, the neural question answering system is configured to determine whether the question token at the encoder time step identifies an entity that is represented in a knowledge base (KB). If the neural question answering system determines that the question token at the encoder time step identifies an entity that is represented in the KB, then the neural network system may add the variable representing the question token to a vocabulary of possible outputs and link the variable to the entity that is represented in the knowledge base.

At step 440, for each question token that satisfied the criteria, the neural question answering system adds the variable to the vocabulary of possible outputs and associates the encoded representation of the question token as an encoded representation of the variable. As such, the neural question answering system can be configured to add the variable to the vocabulary of possible outputs, when the question token satisfies the one or more criteria, and associate the encoded representation as an encoded representation so that the variable may be accessed by the corresponding key. In this instance, the encoded representation may be used by the neural question answering system as a reference indicator that can be used to access the variable via the corresponding encoded representation.

FIG. 5 is a flow diagram of an example process 500 for selecting an output from a vocabulary of possible outputs. For convenience, the process 500 will be described as being performed by a system of one or more computers located in one or more locations. For example, a neural question answering system, e.g., the neural question answering system 120 of FIG. 1, appropriately programmed in accordance with this specification can perform the process 500.

At step 510, the neural question answering system receives a decoder input.

At step 520, the neural question answering system processes the decoder input using a decoder neural network to update a decoder hidden state of the decoder neural network.

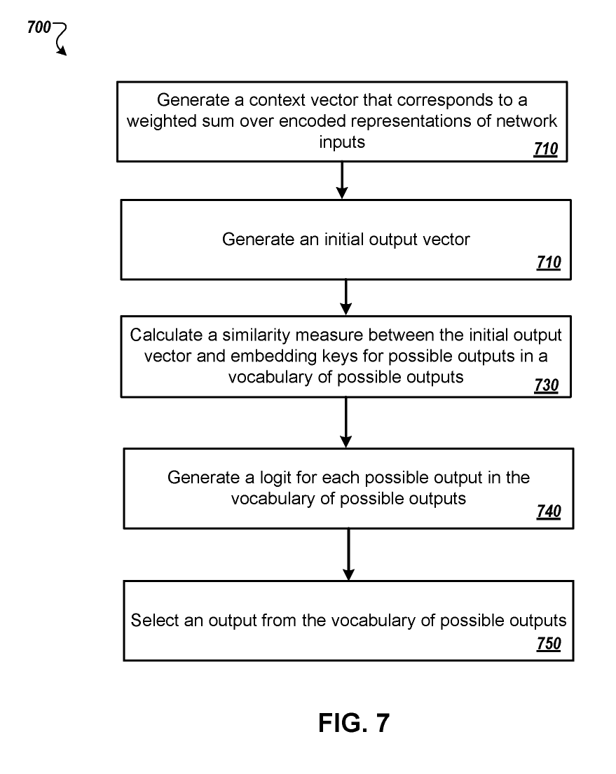

At step 530, the neural question answering system determines a respective output score for each possible output in a vocabulary of possible outputs. For example, the neural question answering system may be configured to determine the respective output scores at each of a plurality of decoder time steps. The neural question answering system can be configured to determine the output scores from an updated decoder hidden state at each decoder time step and from respective encoded representations for the possible outputs in the vocabulary of possible outputs. In some aspects, the neural question answering system is configured to determine the respective output score for each possible output in the vocabulary by applying a softmax over a respective logit for each of the possible outputs. The determination of respective output scores for each possible output in the vocabulary is further described in FIG. 7.

Generally, the vocabulary of possible outputs includes tokens from computer program expressions, and wherein the tokens include, for each of a plurality of functions, a function identifier for the function and possible arguments to the function, including variables that have already been added to the vocabulary during the processing of the question by the system.

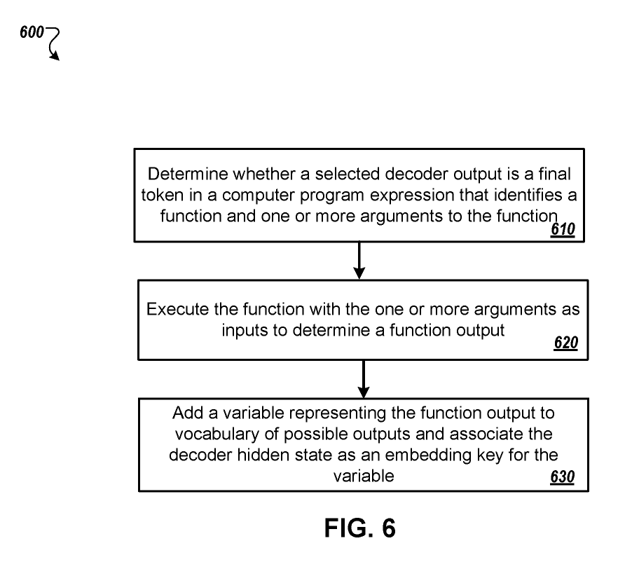

At step 540, the neural question answering system selects an output from the vocabulary of possible outputs. The neural question answering system may select the output from the vocabulary of possible outputs at each of a plurality of decoder time steps. In some aspects, the neural question answering system may select the output from the vocabulary of possible outputs based on the respective output scores. For example, the neural question answering system may select an output in the vocabulary of possible outputs with the greatest respective output score as the output. The selection of an output from a vocabulary of final outputs is further described in FIGS. 6 and 7.

The neural question answering system repeats process 500 until a final output token from the vocabulary of possible outputs is selected as the decoder output. That is, in some examples, the tokens in the vocabulary include a special final output token. In this instance, the neural question answering system can determine whether the selected decoder output at the decoder time step is a special final output token. Additionally, or alternatively, the neural question answering system can select a most recently generated function output as the system output for an input sequence once the selected decoder output at the decoder time step is the special final output token.

FIG. 6 is a flow diagram of an example process 600 for executing a function to determine a function output. For convenience, the process 600 will be described as being performed by a system of one or more computers located in one or more locations. For example, a neural question answering system, e.g., the neural question answering system 120 of FIG. 1, appropriately programmed in accordance with this specification can perform the process 600.

At step 610, the neural question answering system determines whether a selected decoder output is a final token in a computer program expression that identifies a function and one or more arguments to the function. The neural question answering system may be configured to determine whether the selected decoder output is a final token at each of a plurality of decoder time steps.

At step 620, the neural question answering system executes the function with the one or more arguments as inputs to determine a function output. Once the function has been executed to generate a function output, the neural question answering system is configured to add a variable representing the function output to the vocabulary of possible outputs. Further, the neural question answering system may be configured to associate a decoder hidden state at the decoder time step at which the function was executed as an encoded representation for the variable. In this instance, the variable may be accessed by the neural question answering system using the encoded representation.

At step 630, the neural question answering system adds a variable representing the function output to the vocabulary of possible outputs. The neural question answering system also associates the decoder hidden state at the decoder time step as an encoded representation for the variable. In some aspects, the neural question answering system associates each decoder hidden state with an encoded representation corresponding to a particular variable at each of the plurality of decoder time steps.

FIG. 7 is a flow diagram of an example process 700 for selecting an output from a vocabulary of possible outputs using logits. For convenience, the process 700 will be described as being performed by a system of one or more computers located in one or more locations. For example, a neural question answering system, e.g., the neural question answering system 120 of FIG. 1, appropriately programmed in accordance with this specification can perform the process 700.

At step 710, the neural question answering system generates a context vector that corresponds to a weighted sum over encoded representations of question tokens. The neural question answering system can generate the context vector using the updated decoder hidden state at each of the decoder time steps. For example, the system can apply a conventional attention mechanism to the decoder output and the encoder representation to generate the weights for the weighted sum.

At step 720, the neural question answering system generates an initial output vector. The neural question answering system can be configured to generate the initial output vector using the updated decoder hidden state and the context vector that corresponds to the weighted sum over the encoded representation of the question tokens. For example, the system can add, multiply, concatenate, or otherwise combine the decoder hidden state and the context vector to generate the initial output vector.

At step 730, the neural question answering system calculates a similarity measure between the initial output vector and encoded representations for possible outputs in a vocabulary of possible outputs. The neural question answering system may calculate a similarity measure at each of a plurality of decoder time steps. Further, the neural question answering system can calculate the similarity measure for at least a plurality of the encoded representations.

At step 740, the neural question answering system generates a logit for each possible output in the vocabulary of possible outputs. The neural question answering system may generate the logit for the possible outputs using the calculated similarity measure between the initial output vector and the respective encoded representations for possible outputs in the vocabulary of possible outputs.

At step 750, the neural question answering system selects a valid output from the vocabulary of possible outputs using the logits.

In particular, before selecting the output, the system determines which outputs would be valid, i.e., which outputs would not cause a semantic error or a syntax error when following the preceding output in the output sequence, and then selects an output from only the valid possible outputs. For example, the system can select the valid output having the highest logit or set the logits for invalid outputs to negative infinity, apply a softmax the logits for the possible outputs to generate a respective probability for each possible output (with the probabilities for invalid outputs being zero due to the logits being set to negative infinity) and then sample an output in accordance with the probabilities.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Particular embodiments of the invention have been described. Other embodiments are within the scope of the following claims. For example, the steps recited in the claims can be performed in a different order and still achieve desirable results.

What is claimed is:

1. A system comprising one or more computers and one or more storage devices storing instructions that when executed by the one or more computers cause the one or more computers to implement:
an encoder neural network configured to:
receive an input question sequence comprising a respective question token at each of a plurality of encoder time steps, and
for each of the encoder time steps, process the question token at the encoder time step to generate an encoded representation of the question token;
a decoder recurrent neural network configured to, at each of a plurality of decoder time steps:
receive a decoder input at the decoder time step, and
process the decoder input and a preceding decoder hidden state to generate an updated decoder hidden state for the decoder time step; and
a subsystem configured to:
at each of the encoder time steps:
determine whether the question token at the encoder time step satisfies one or more criteria for adding a variable representing the question token to a vocabulary of possible outputs; and
when the question token at the encoder time step satisfies the one or more criteria, add the variable to the vocabulary of possible outputs and associate the encoded representation of the question token as an encoded representation for the variable; and
at each of the decoder time steps:
determine, from the updated decoder hidden state at the decoder time step and from respective encoded representations for possible outputs in the vocabulary of possible outputs, a respective output score for each possible output in the vocabulary of possible outputs, and
select, using the output scores, an output from the vocabulary of possible outputs as a decoder output at the decoder time step.

2. The system of claim 1, wherein the possible outputs in the vocabulary of possible outputs are tokens from computer program expressions, and wherein the tokens include, for each of a plurality of functions, a function identifier for the function and possible arguments to the function.

3. The system of claim 2, wherein determining whether the one or more criteria are satisfied comprises:
determining whether the question token at the encoder time step identifies an entity that is represented in a knowledge base; and wherein the subsystem is further configured to:
in response to determining that the question token at the encoder time step identifies an entity that is represented in the knowledge base, linking the variable representing the question token to the entity that is represented in the knowledge base.

4. The system of claim 2, wherein selecting the output from the vocabulary of possible outputs comprises:
identifying as a valid output for the decoder time step any output from the vocabulary of possible outputs that would not cause a semantic error or a syntax error when following an output at the preceding decoder time step; and
selecting the output only from the valid outputs for the decoder time step.

5. The system of claim 2, wherein the subsystem is further configured to, at each of the decoder time steps:
determine whether the selected decoder output at the decoder time step is a final token in a computer program expression that identifies a function and one or more arguments to the function; and
when the selected decoder output at the decoder time step is a final token in a computer program expression that identifies a function and one or more arguments to the function:
execute the function with the one or more arguments as inputs to determine a function output.

6. The system of claim 5, wherein the subsystem is further configured to, when the selected decoder output at the decoder time step is a final token in a computer program expression that identifies a function and one or more arguments to the function:
add a variable representing the function output to the vocabulary of possible outputs and associate the decoder hidden state at the decoder time step as an encoded representation for the variable.

7. The system of claim 6, wherein the tokens further include a special final output token, and wherein the subsystem is further configured to, at each of the decoder time steps:
determine whether the selected decoder output at the decoder time step is the special final output token; and
when the selected decoder output at the decoder time step is the special final output token:
select a most recently generated function output as a system output for the input sequence.

8. The system of claim 1, wherein the subsystem is further configured to, at each of the decoder time steps:
generate, using the updated decoder hidden state at the decoder time step, a context vector that corresponds to a weighted combination of the encoded representations of the question tokens; and
generate, using the updated decoder hidden state at the decoder time step and the context vector that corresponds to the weighted sum over the encoded representation of the question tokens, an initial output vector at the decoder time step.

9. The system of claim 8, wherein the subsystem is further configured to, at each of the decoder time steps:
calculate, for at least a plurality of the encoded representations, a similarity measure between the initial output vector at the decoder time step and the respective encoded representations for the possible outputs in the vocabulary of possible outputs; and
generate, using the calculated similarity measure between the initial output vector at the decoder time step and the respective encoded representations for the possible outputs in the vocabulary of possible outputs, a respective logit for each possible output in the vocabulary of possible outputs.

10. The system of claim 9, wherein the subsystem is configured to, at each of the decoder time steps:
select, using the respective output score for each possible output in the vocabulary of possible outputs and the logits for each possible output in the vocabulary of possible outputs, an output from the vocabulary of possible outputs as a decoder output at the decoder time step.

11. The system of claim 9, wherein the subsystem is configured to determine the respective output score for each possible output in the vocabulary of possible outputs by applying a softmax over the respective logit for each possible output in the vocabulary of possible outputs.

12. The system of claim 11, wherein the subsystem is configured to, prior to determining the respective output score for each possible output, set the logit for outputs from the vocabulary of possible outputs that would not be valid outputs for the decoder time step to a value that is mapped to zero by the softmax.

13. One or more non-transitory computer-readable storage media storing instructions that when executed by one or more computers cause the one or more computers to implement:
an encoder neural network configured to:
receive an input question sequence comprising a respective question token at each of a plurality of encoder time steps, and
for each of the encoder time steps, process the question token at the encoder time step to generate an encoded representation of the question token;
a decoder recurrent neural network configured to, at each of a plurality of decoder time steps:
receive a decoder input at the decoder time step, and
process the decoder input and a preceding decoder hidden state to generate an updated decoder hidden state for the decoder time step; and
a subsystem configured to:
at each of the encoder time steps:
determine whether the question token at the encoder time step satisfies one or more criteria for adding a variable representing the question token to a vocabulary of possible outputs; and
when the question token at the encoder time step satisfies the one or more criteria, add the variable to the vocabulary of possible outputs and associate the encoded representation of the question token as an encoded representation for the variable; and
at each of the decoder time steps:
determine, from the updated decoder hidden state at the decoder time step and from respective encoded representations for possible outputs in the vocabulary of possible outputs, a respective output score for each possible output in the vocabulary of possible outputs, and
select, using the output scores, an output from the vocabulary of possible outputs as a decoder output at the decoder time step.

14. The computer-readable storage media of claim 13, wherein the possible outputs in the vocabulary of possible outputs are tokens from computer program expressions, and wherein the tokens include, for each of a plurality of functions, a function identifier for the function and possible arguments to the function.

15. The computer-readable storage media of claim 13, wherein determining whether the one or more criteria are satisfied comprises:
determining whether the question token at the encoder time step identifies an entity that is represented in a knowledge base; and wherein the subsystem is further configured to:
in response to determining that the question token at the encoder time step identifies an entity that is represented in the knowledge base, linking the variable representing the question token to the entity that is represented in the knowledge base.

16. The computer-readable storage media of claim 14, wherein selecting the output from the vocabulary of possible outputs comprises:
identifying as a valid output for the decoder time step any output from the vocabulary of possible outputs that would not cause a semantic error or a syntax error when following an output at the preceding decoder time step; and
selecting the output only from the valid outputs for the decoder time step.

17. The computer-readable storage media of claim 14, wherein the subsystem is further configured to, at each of the decoder time steps:
determine whether the selected decoder output at the decoder time step is a final token in a computer program expression that identifies a function and one or more arguments to the function; and
when the selected decoder output at the decoder time step is a final token in a computer program expression that identifies a function and one or more arguments to the function:
execute the function with the one or more arguments as inputs to determine a function output.

18. The computer-readable storage media of claim 17, wherein the subsystem is further configured to, when the selected decoder output at the decoder time step is a final token in a computer program expression that identifies a function and one or more arguments to the function:
add a variable representing the function output to the vocabulary of possible outputs and associate the decoder hidden state at the decoder time step as an encoded representation for the variable.

19. The computer-readable storage media of claim 6, wherein the tokens further include a special final output token, and wherein the subsystem is further configured to, at each of the decoder time steps:
determine whether the selected decoder output at the decoder time step is the special final output token; and
when the selected decoder output at the decoder time step is the special final output token:
select a most recently generated function output as a system output for the input sequence.

20. The computer-readable storage media of claim 1, wherein the subsystem is further configured to, at each of the decoder time steps:
generate, using the updated decoder hidden state at the decoder time step, a context vector that corresponds to a weighted combination of the encoded representations of the question tokens; and
generate, using the updated decoder hidden state at the decoder time step and the context vector that corresponds to the weighted sum over the encoded representation of the question tokens, an initial output vector at the decoder time step.
